(19) United States
(12) Patent Application Publication
(10) Pub. No.: US 2009/0161357 A1
(43) Pub. Date: Jun. 25, 2009

(54) LIGHTBOX WITH DRYER

(75) Inventors: Stephen J. Carlson, Shorewood, MN (US); Thomas J. Midas, Oak Park Heights, MN (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: Red Devil Equipment Company, Plymouth, MN (US)

(21) Appl. No.: 12/120,374

(22) Filed: May 14, 2008

Related U.S. Application Data
(60) Provisional application No. 61/014,838, filed on Dec. 19, 2007.

(51) Int. Cl. F21V 33/00; F26B 19/00

(52) U.S. Cl. 362/234; 34/90; 34/629

(57) ABSTRACT

A lightbox and dryer apparatus combined in a single enclosure and having a plurality of types of illumination sources to view paint samples and a forced convection air drying mechanism having at least one air blower selectively providing forced convection air for drying custom mixed paint samples. In one alternative, a radiant heat source may be used with the unheated forced convection air to dry the sample. In another alternative a heating element is selectively operable to heat the forced convection air directed at the sample to be dried. The types of illumination sources may include fluorescent, incandescent and synthetic sunlight. The apparatus may also include a roller or supporting clip to retain the sample in a dryer section at the outlet of the dryer. Optionally a drying surface may be provided in the dryer section.

### CROSS REFERENCE TO RELATED APPLICATION

This application claims the benefit of U.S. Provisional Application No. 61/014,838, filed Dec. 19, 2007, the entire contents of which are hereby expressly incorporated by reference.

### TECHNICAL FIELD

The present invention relates to the field of lightboxes used to view paint samples under different forms of illumination.

### BACKGROUND

In the past, lightboxes having different forms of illumination were sometimes used to view paint samples under different forms of illumination, such as fluorescent, incandescent or even synthesized “natural” light, to permit a consumer to observe the effect of such forms of illumination on paint samples to enable the consumer to make an appropriate selection of the color, tint and hue of paint for redecorating. However, such lightboxes were only suitable for viewing dried paint samples, whether selected from inventory in the paint store or custom prepared and manually dried before viewing.

### SUMMARY

In one aspect, the present invention overcomes shortcomings of the prior art by providing a lightbox and dryer in a single unified apparatus, thus enabling rapid drying followed by immediate inspection under a selected type or source (or a plurality of types of sources) of illumination. The present invention thus reduces the amount of shelf or counter space that would have otherwise been required for a separate dryer and lightbox, provides convenience of drying and viewing functions performed in the same apparatus, and provides improved convenience in drying one paint sample or set of samples at the same time that another paint sample or set of samples is being viewed.

The present invention may use heated or unheated forced convection air to dry the paint sample and may include means to hold a card carrying the paint sample in the path of the drying air. The present invention may also include a separate viewing tray, allowing a user to conveniently and repeatably position the dried paint sample under the selected illumination source.

In one aspect, the present invention may include a radiant heater with unheated forced convection air to dry the sample.

In another aspect, the present invention may have different types of illumination sources including fluorescent, incandescent and natural light.

In another aspect, the present invention may be a dryer apparatus using radiant heat transfer to dry a paint sample including a blower selectively delivering forced convection air to dry a paint sample located in the dryer apparatus and a radiant heat source directed to dry the paint sample.

### BRIEF DESCRIPTION OF THE DRAWINGS

FIG. 1 is a perspective view from above of a lightbox and dryer of the present invention.

FIG. 2 is a perspective view from below of the apparatus of FIG. 1.

FIG. 3 is a side view with a left hand panel cover panel removed to illustrate the arrangement of parts within the apparatus of FIG. 1.

FIG. 4 is a perspective view of the apparatus of FIG. 3.

FIG. 5 is a view of an illumination section and a dryer section from FIG. 4.

FIG. 6 is a front elevation view of the illumination section together with parts from the dryer section (with certain cover panels removed therefrom to illustrate internal features thereof), along with a pair of hold-down mechanisms and a tile support plate for supporting the card with the paint sample while drying.

FIG. 7 is a perspective view from below of the illumination section and the dryer section of FIG. 5 (with certain cover panels removed from the dryer section to better illustrate certain features thereof).

FIG. 8 is an enlarged view of the dryer section of FIG. 7 with certain cover panels removed to better illustrate internal features of this section.

FIG. 9 is an elevation view of the dryer section from the rear with a rear heater cover panel removed to better illustrate certain internal features thereof.

FIG. 10 is a perspective view from the side and front of the dryer section of FIG. 9, still with the rear heater cover panel removed.

FIG. 11 is a perspective view similar to that of FIG. 10, except with a front heater cover panel removed to better illustrate the arrangement of a heating element and air blowers of the present invention.

FIG. 12 is an exhaust end view of FIG. 11.

FIG. 13 is an electrical schematic for the present invention.

FIG. 14 is a front elevation view of an alternative embodiment useful in the practice of the present invention.

FIG. 15 is a side elevation view in section along line XV-XV of FIG. 14.

### DETAILED DESCRIPTION

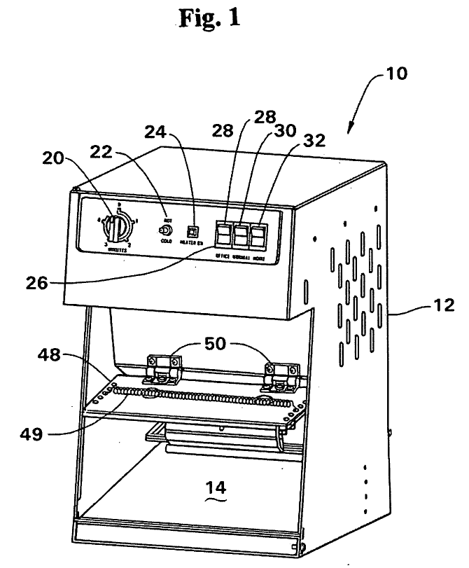

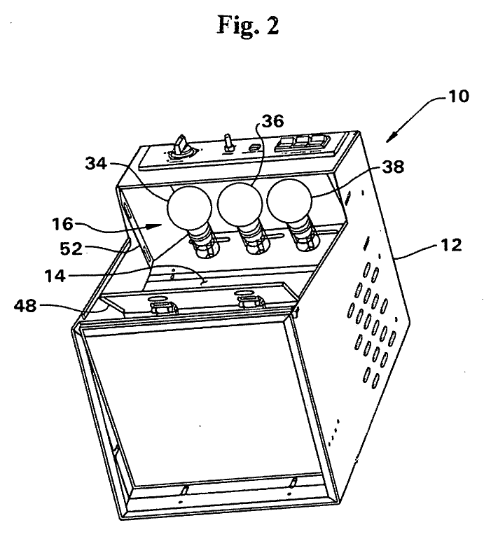

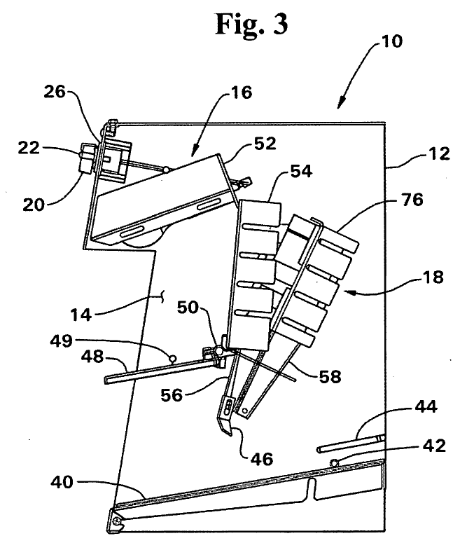

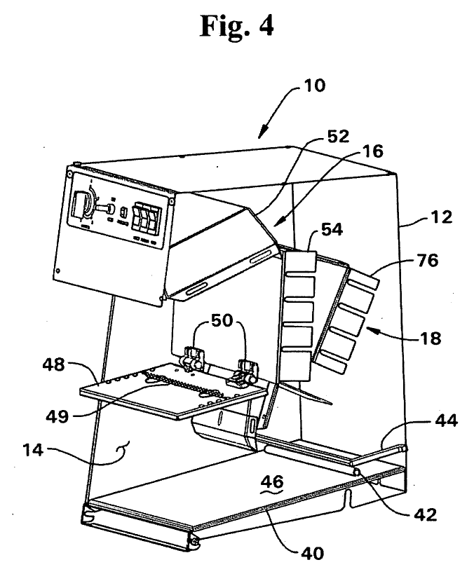

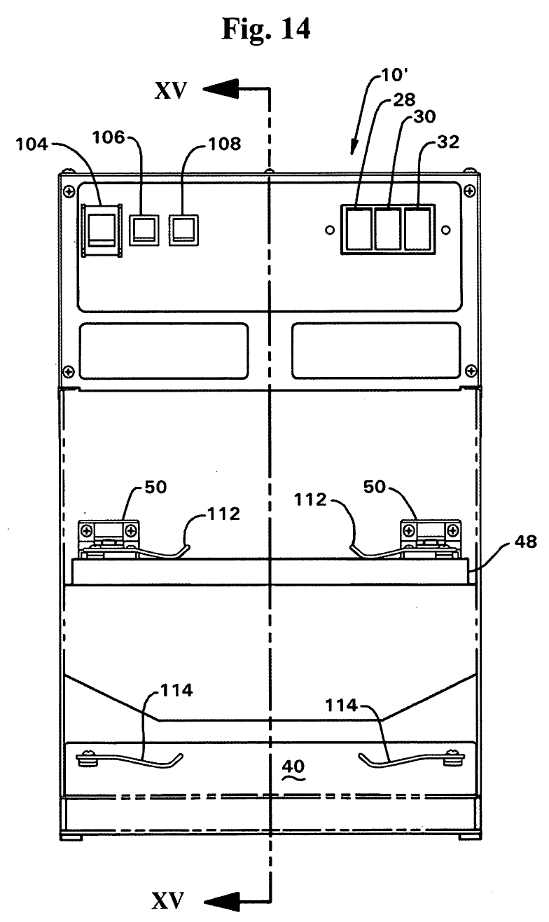

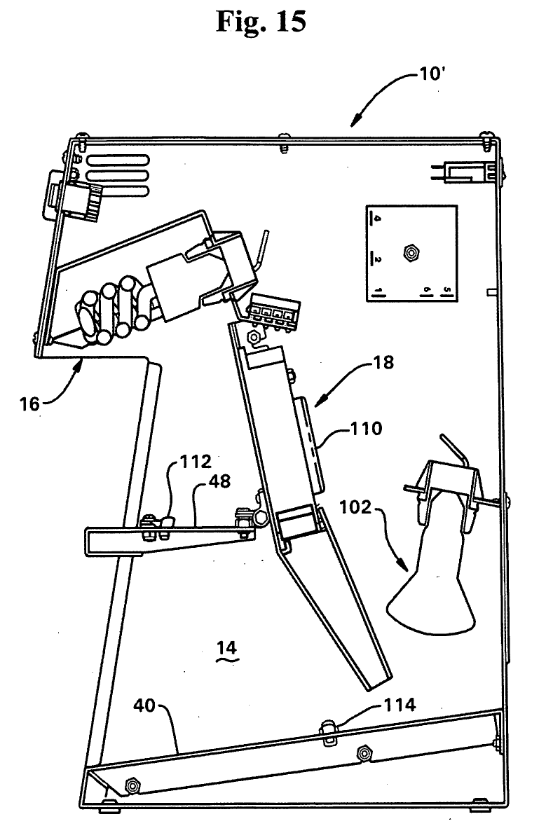

Referring to the Figures, and most particularly to FIGS. 1-4, one embodiment of a lightbox and dryer apparatus 10 useful in the practice of the present invention may be seen. In FIGS. 1 and 2, the apparatus of this embodiment is shown in its entirety, with an enclosure 12 surrounding all but the front side of the apparatus 10, which has an opening 14 for a user to insert a card or other substrate with a paint sample thereon (not shown) first for drying and then for observation under a selected source of illumination. It is to be understood that other embodiments of this invention preferably will have an enclosure which may be the same or similar to enclosure 12, as may be seen in FIGS. 14 and 15.

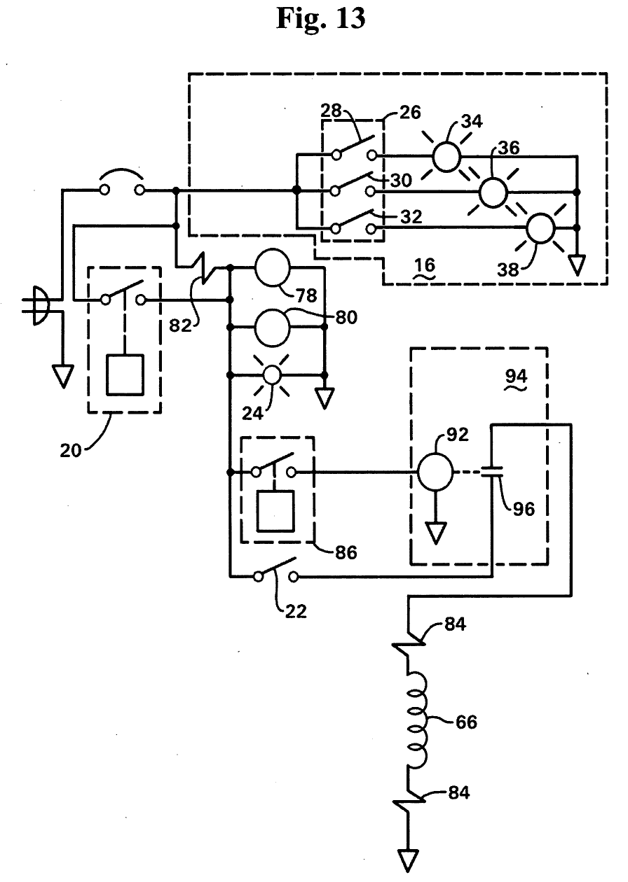

Referring now also to FIG. 13 showing an electrical schematic for one embodiment of the present invention, apparatus 10 may contain an illumination section or subassembly 16 and a dryer section or subassembly 18. Apparatus 10 may also include a timer 20, a HOT/COLD selector switch 22, an ON indicator 24, and a bank 26 of illumination selector switches 28, 30, and 32. Switch 28 may be used to select fluorescent illumination by energizing bulb 34, which may be a fluorescent bulb. Switch 30 may be used to select incandescent illumination by energizing bulb 36, which may be a conventional incandescent bulb. Switch 32 may be used to select “natural” or synthetic sunlight illumination by energizing bulb 38 which may be a “natural” or sunlight simulating bulb. This optionally allows a user to simulate daylight illumination of the paint sample intended for indoor application. It is to be understood that other types of illumination and various wattages of illumination sources may be used in the present invention. The various types of illumination sources mentioned above are distinguishable by the different spectral characteristic of each type of illumination source.

Timer 20 may be, for example, a timer having a predetermined time-out function to turn on the dryer section 18. For example, and not by way of limitation, 3 or 5 minute timer functions may be provided.

The dryer section 18 of apparatus 10 may further include a drying surface 40, (preferably heat resistant) and surface 40 may be formed of refractory material such as a ceramic tile, although it is to be understood that other heat resistant materials may be used in the practice of the present invention. It is preferable that the material of surface 40 have low thermal conductivity. A roller 42 supported and retained by a generally U-shaped clip 44 (each of which are shown only schematically) or other retention device may be used to retain the card with the paint sample to be dried (not shown) on the surface 40 during the drying process. Other forms of retention of the paint sample may be used while still staying within the scope of the present invention. For example, and not by way of limitation, one or more spring clips may be used to hold the paint sample in the apparatus 10. As a still further alternative, in certain configurations, it may not be necessary for a separate mechanical means for retaining the paint sample; the airflow itself may provide the function of retaining the paint sample in a drying position located to receive air exiting from the drying section 18.

In operation, a paint sample on a suitable substrate is placed on surface 40 below an outlet deflector 46 of the dryer section 18 and (optionally) retained by a retention device thereon. The timer 20 is then activated to energize the dryer section which then provides heated (or unheated) forced convection air against the paint sample to dry the paint. Once the paint sample is dry, the paint sample (on its substrate, such as card stock) optionally can then removed from the retention device (if present) and from the drying position in the dryer section. The paint sample is then preferably placed in the illumination section 16, optionally on a tray 48 and one of the switches in bank 26 is actuated to selectively energize a desired type of illumination, i.e., a type with a desired defining feature such as spectral characteristic, color temperature, or correlated color temperature (for “non-black body” types of illumination sources). Selection of the desired type of illumination enables viewing of the paint sample in the illumination section 16 of the apparatus 10 as it would appear when illuminated by that type of illumination (in the actual environment) after decorating or redecorating with that paint. Optionally, a user may choose to view the paint sample without moving it to the tray 48, but instead, leaving it on the surface 40, either in the drying position or relocating it to another place on surface 40 or elsewhere in apparatus 10. Tray 48 may be mounted to apparatus 10 using, for example, friction hinges 50, to permit orienting tray 48 at different angles to the bulbs to view the paint sample with different angles of incident light impinging thereon. It is to be understood that tray 48 may be used to view one or more samples while another sample is being dried in the dryer section. As shown in FIGS. 1, 3, and 4, a spring 49 may be attached to tray 48 to retain the sample being viewed on tray 48, if desired.

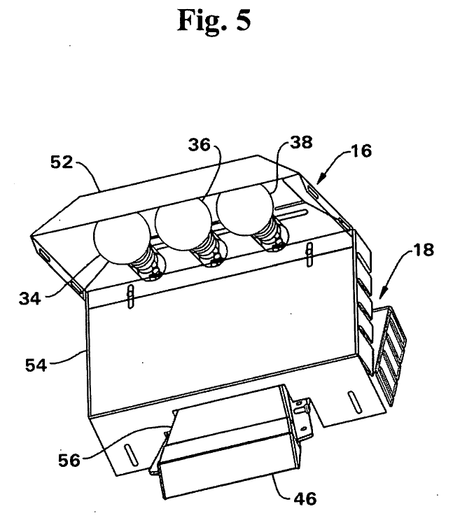

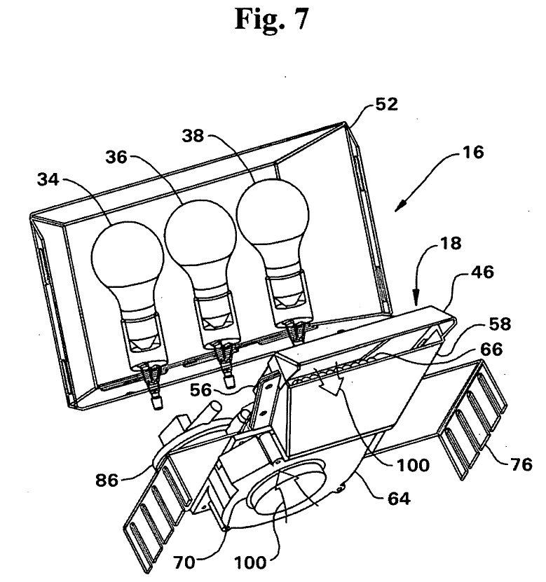

Referring now also to FIGS. 5, 6 and 7, various views of parts of the illumination section 16 and dryer section 18 of one embodiment may be seen. FIG. 5 shows the two subassemblies 16 and 18 joined together by attachment of sheet metal panels associated with the respective subassemblies. Specifically a hood 52 of the illumination section 16 is joined to a front upper cover 54 of the dryer section 18. In one embodiment, a front heater cover 56 and a rear heater cover 58 form an air channel 60 to direct air from a front blower 62 and a rear blower 64 across a heater element 66 after which it is directed by outlet deflector 46 towards the drying surface 40 for this embodiment. Front blower 62 has an air inlet 68, and rear blower has an air inlet 70. Front blower 62 has an air outlet 72 and rear blower 64 has an air outlet 74, each delivering air to air channel 60. It is to be understood that the present invention may be practiced with a single blower or more than two blowers, if desired. Two blowers have been used in the embodiment shown for reasons of space and cost. It is to be understood that the blower or blowers may be used with or without heating the air delivered for drying the paint sample.

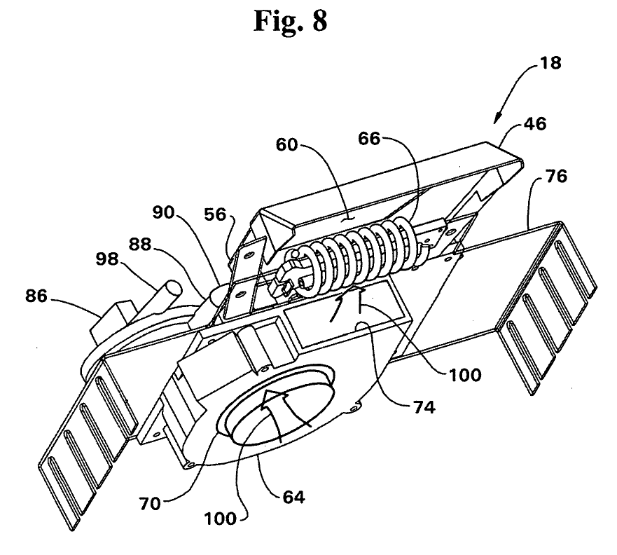

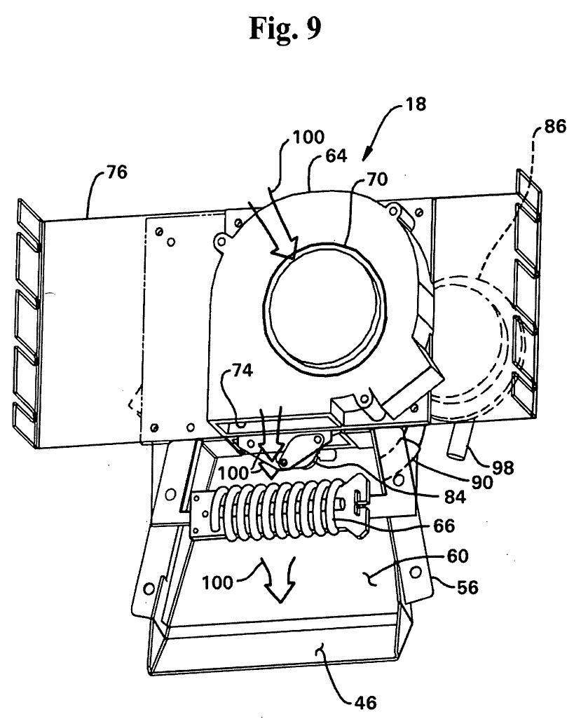

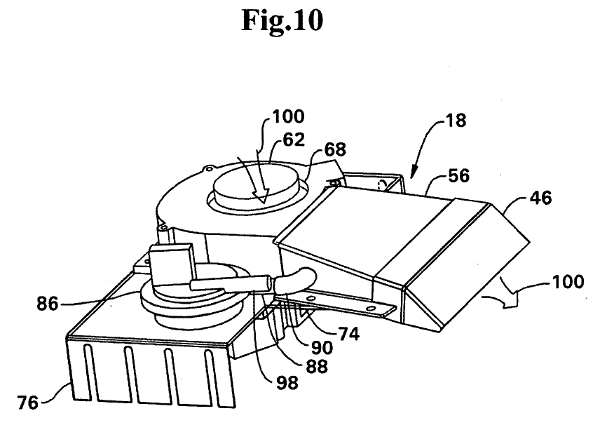

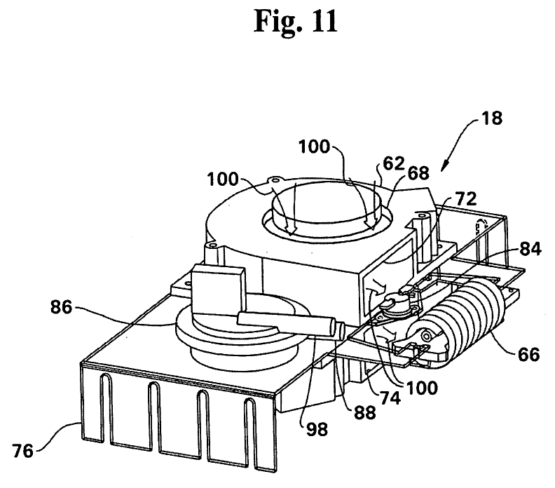

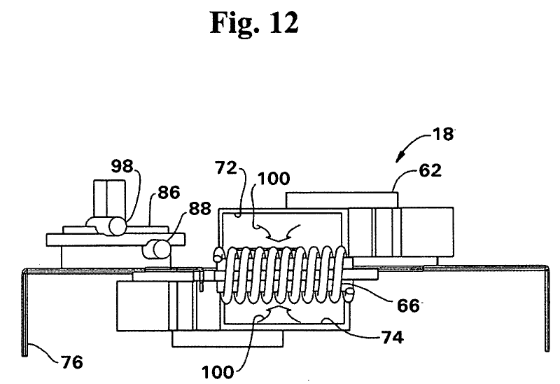

Referring now also to FIGS. 8-12, various views of the dryer section 18 may be seen with various (and different) parts omitted among these views, to more clearly show certain aspects of this embodiment of the present invention. Each of these views show an upper rear cover 76 to which the blowers or fans 62 and 64 are attached. The blowers 62 and 64 have, respectively, an electric motor 78 and 80 (see FIG. 13) to provide motive power to the respective impellers (not shown) to provide either heated or non-heated forced convection air for drying the paint sample. The switch 22 may be used to energize the heating element 66 to provide heated air when desired. Leaving switch 22 open will provide non-heated air when the blowers are energized by timer 20.

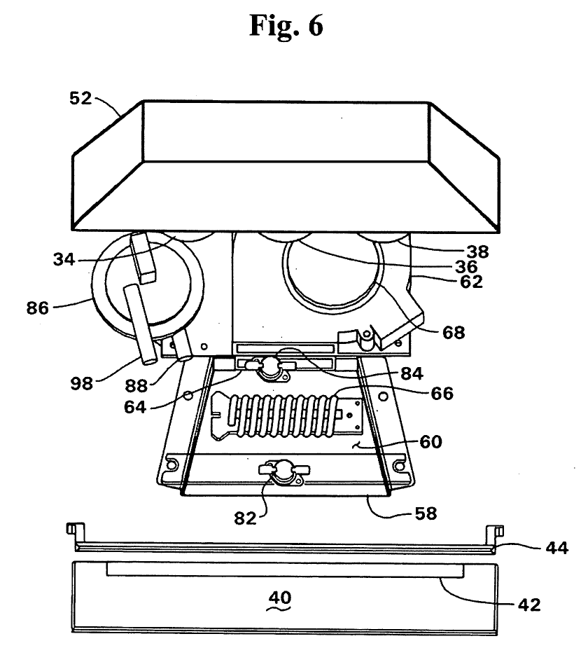

As may be seen in FIGS. 6 and 13, optionally a normally open thermal cutout switch 82 may be physically positioned in the air channel 60, downstream of the heater element 66, it being understood that, when present, cutout switch 82 is electrically connected across timer 20, so that once the air in channel 60 is heated, switch 82 will close in response to the increase in air temperature in channel 60. The blowers will then remain ON after the timer 20 times out and opens the circuit to the heater element 66. The blowers will remain ON until the air temperature at cutout switch 82 drops to a lower level at which time the cutout switch 82 will revert to its normally open state and remove power from the blower motors 78 and 80, turning each of them OFF.

In this embodiment, optionally a pair of thermal cutouts 84 may be physically positioned in the air channel 60 upstream of the heater element 66 (as shown in FIGS. 6, 9 and 11) and electrically positioned in series with the heater element 66 (as shown in FIG. 13), to prevent an overtemperature condition in the event of electrical or mechanical failure of one or both blowers 62, 64, it being understood that each cutout 84 is normally closed and will electrically open in the event of sensing an overtemperature condition. Alternatively, only one thermal cutout 84 may be used in the practice of the present invention, if desired.

Also in this embodiment, an optional an air pressure sensor switch 86 may be used in the practice of this invention. When used, sensor switch will preferably have a first inlet 88 connected via a tube 90 to the air channel 60 to measure air pressure in the air channel 60. The air pressure switch 86 is electrically connected to a relay coil 92 of a relay 94. Contact 96 of relay 94 must be closed (by applying power to coil 92) before electrical power will be delivered to heater element 66. Air pressure switch 86 has a second inlet 98 open to ambient pressure external of the dryer section 18 to provide an ambient air pressure reference for the air pressure sensor switch, it being understood that ambient air pressure is subject to the barometric and altitude environmental conditions present at the apparatus 10.

Arrows 100 in the various figures represent the direction air will flow when the blowers 62 and 64 are ON.

In one aspect, the invention may thus be seen to be a combined lightbox and dryer apparatus for drying paint samples and thereafter viewing the dried paint sample, including an illumination section and a dryer section with each section contained within a single enclosure and separately operable. Optionally, the dryer section may have a drying surface. The dryer section will have a blower selectively delivering forced convection air to dry a paint sample (located on a suitable substrate, such as a card) in the drying section. The illumination section has at least one illumination source to selectively view the paint sample as illuminated by the at least one illumination source.

In another aspect, the at least one illumination source includes a plurality of types of illumination sources, which may include fluorescent, incandescent and natural light types of illumination sources. It is also to be understood to be within the practice of the present invention to optionally have more than one bulb for some or all of the various types of illumination sources.

In another aspect, the invention may be seen to further include a heater element to heat the forced convection air. In this aspect, and when included in the dryer section, the drying surface is preferably formed of a heat resistant material, such as a refractory material.

In another aspect, the invention may be seen to further include a timer for limiting the amount of time the heater element or the blower or both are turned on.

In another aspect, the invention may be seen to further (optionally) include an air pressure sensor switch connected to prevent the heater element from being electrically energized unless the blower is energized.

In another aspect, the invention may be seen to further (optionally) include at least one thermal cutout switch to deenergize the heater element in the event of an overtemperature condition.

In another aspect, the invention may be seen to further (optionally) include a tray for receiving the paint sample to position the paint sample (on the substrate) with respect to the illumination section (more particularly with respect to the illumination sources).

In another aspect, when included, the tray may be movable with respect to the illumination section (more particularly with respect to the illumination sources).

In another aspect, the invention may be seen to further include a plurality of types of illumination sources including at least one fluorescent bulb, at least one incandescent bulb and at least one natural light bulb.

In another aspect, the invention may be seen to further include means for retaining a substrate containing the paint sample on the heat resistant surface to prevent movement of the substrate in the presence of forced convection air directed at the paint sample.

More particularly, the means for retaining the substrate may include a roller or a clip which may be generally U-shaped, if desired. Other types and shapes of clips are to be understood to be within this aspect of the present invention.

Referring now most particularly to FIGS. 14 and 15 an alternative embodiment 10′ of the present invention may be seen. It is to be understood that this embodiment differs from that described above in that a radiant heat source 102 (which may be separate from the air flow path) is included in the dryer section of this embodiment which also has a forced convection air blower. The dryer section of this embodiment may or may not also include one or more heater elements 66 to heat the forced convection air. In other words, this embodiment of the lightbox and dryer 10′ may, in one version, have only unheated forced convection air to provide drying with or without the radiant heat source 102. The lightbox and dryer 10′ of this embodiment preferably has an ON-OFF switch 104 and separate pushbuttons 106 and 108, respectively, for a short-time timer, for example a 3 minute timer and a longer-time timer, for example, a 5 minute timer.

Apparatus 10′ preferably has a blower 110 to provide the forced convection air, and also may have a heater (not shown in FIGS. 14 or 15). Tray 48 may have a pair of spring clips 112 to retain the paint sample for viewing. Similarly surface 40 may also have a pair of spring clips 114 to retain the paint sample (and substrate) on the drying surface 40, when desired.

The invention is not to be taken as limited to all of the details thereof as modifications and variations may be made without departing from the spirit or scope of the invention.

1. A combined lightbox and dryer apparatus for drying paint samples and thereafter viewing the dried paint sample comprising:
a) an illumination section having a plurality of illumination sources which are individually selectable to view the paint sample under a selected source of illumination; and
b) a dryer section with a blower selectively delivering forced convection air to dry a paint sample in the drying section
wherein both sections are contained within a single enclosure and wherein each section is separately operable.

2. The apparatus of claim 1 wherein the plurality of illumination sources further comprise at least two types of illumination sources with each type of source having a different spectral characteristic from at least one other type of illumination source.

3. The apparatus of claim 1 wherein the dryer section further comprises a timer for limiting the amount of time the blower is turned on.

4. The apparatus of claim 1 wherein the forced convection air is unheated.

5. The apparatus of claim 1 wherein the dryer section further comprises a heater element to selectively heat the forced convection air.

6. The apparatus of claim 5 wherein the dryer section further comprises a drying surface formed of a heat resistant material.

7. The apparatus of claim 5 further comprising a timer for limiting the amount of time the heater element is turned on.

8. The apparatus of claim 5 further comprising an air pressure sensor switch electrically connected to control the heater and operative to prevent the heater element from being electrically energized unless the blower is energized.

9. The apparatus of claim 5 further comprising at least one thermal cutout switch to deenergize the heater element in the event of an overtemperature condition.

10. The apparatus of claim 1 further comprising a tray for receiving the paint sample to position the paint sample with respect to the illumination section.

11. The apparatus of claim 10 wherein the tray is movable with respect to the illumination section.

12. The apparatus of claim 1 wherein the plurality of types of illumination sources includes at least one fluorescent bulb, at least one incandescent bulb and at least one natural light bulb.

13. The apparatus of claim 1 further comprising means for retaining a substrate containing the paint sample on the drying surface to prevent movement of the substrate in the presence of forced convection air directed at the drying surface.

14. The apparatus of claim 13 wherein the means for retaining a substrate containing the paint sample comprises a spring clip.

15. A combined light box and dryer apparatus using convective heat transfer to dry paint samples and thereafter viewing the dried paint sample comprising:
a) a dryer section having
i) a blower selectively delivering forced convection air to dry a paint sample in the dryer section, and
ii) a heater connected to selectively heat air delivered by the blower; and
b) an illumination section having a plurality of types of illumination sources, each type having a different spectral characteristic, wherein an individual type of illumination source is selectable to illuminate the paint sample.

16. The apparatus of claim 15 wherein at least some of the forced convection air is recirculated through the blower.

17. The apparatus of claim 15 further comprising a timer operative to turn on the heater when the timer is running and operative to turn off the heater when the timer times out.

18. The apparatus of claim 15 further comprising a drying surface located in the dryer section to receive the paint sample to be dried

19. A combined light box and dryer apparatus using radiant heat transfer to dry paint samples and thereafter enabling viewing the dried paint sample, the apparatus comprising:
a) a dryer section having
i) a blower selectively delivering forced convection air to dry a paint sample in the dryer section, and
ii) a radiant heat source to dry the paint sample in the dryer section; and
b) an illumination section having a plurality of types of illumination sources, each type having a different spectral characteristic, wherein an individual type of illumination source is selectable to illuminate the paint sample.

20. The combined light box and dryer apparatus of claim 19 further comprising a drying surface located in the dryer section to receive the paint sample to be dried.

21. A dryer apparatus using radiant heat transfer to dry a paint sample comprising:
a) a blower selectively delivering forced convection air to dry a paint sample located in the dryer apparatus; and
b) a radiant heat source directed to dry the paint sample.

22. The dryer apparatus of claim 21 further comprising a drying surface to receive the paint sample to be dried.

23. The drying apparatus of claim 21 further comprising a timer to limit the amount of time the radiant heat source is ON.
